(19) United States
(12) Patent Application Publication
(10) Pub. No.: US 2010/0141556 A1
(43) Pub. Date: Jun. 10, 2010

(54) Ophthalmic display

(76) Inventors: Renaud Moliton, Paris (FR); Cecile Bonafos, Paris (FR); Benjamin Rousseau, Charenton-Le-Pont (FR)

Correspondence Address: SOFER & HAROUN LLP., 317 MADISON AVENUE, SUITE 910, NEW YORK, NY, 10017, US

(21) Appl. No.: 11/977,581

(22) Filed: Oct. 25, 2007

(30) Foreign Application Priority Data
Apr. 28, 2005 (FR) 05 51102
Mar. 23, 2006 (FR) PCT/FR2006/050251

(51) Int. Cl. G09G 5/00; G02F 1/01; G02F 1/13

(52) U.S. Cl. 345/8; 359/277; 349/1

(57) ABSTRACT

The invention relates to an ophthalmic display comprising an optical imager both for shaping light beams emitted by a miniature screen of a light-beam generator system for generating light beams that are introduced into said imager via an inlet face, and for directing them towards the eye of the wearer so as to make it possible to view an image, an adapter being in a reference position relative to the imager, and said light-beam generator system including a connection arrangement for connection to said adapter, the connection between said system and said adapter being releasable. In the invention, said adapter is constituted by two snap-fastener hooks for housing in housings carried by said connection arrangement.

The present invention relates to an ophthalmic display comprising an optical imager that makes it possible to project information of the image or multimedia type, and that is preferably associated with a lens. The term “lens” is used herein to designate an optical system that can, in particular, be positioned in an eyeglass frame.

### BACKGROUND OF THE INVENTION

It is known from U.S. Pat. No. 5,886,822 to make an ophthalmic lens that presents a projector insert. Such a projector insert is constituted by an optical imager for shaping the light beams coming from an electronic and optical light-beam generator system of the miniature screen, laser diode, or light-emitting diode type, for generating light beams from an electronic signal. The optical imager directs the light beams towards the eye of the wearer so as to make it possible to view the information content.

An example of a known display is shown diagrammatically in greater detail in FIG. 1.

By way of example, the optical imager is of the same type as the optical imager described in above-mentioned U.S. Pat. No. 5,886,822.

An electronic signal carrying information is delivered to a miniature screen 1 via a cable 7. From that signal, the miniature screen 1, illuminated by a back light, generates a pixel image that corresponds to the information. By way of example, it is possible to use a “KOPIN Cyberdisplay 320 color” screen that generates images having 320×240 pixels and that is 4.8 millimeters (mm)×3.6 mm in size. The position of the screen 1 is referenced relative to the optical imager 5 by means of a mechanical interface. A protective casing protects all or part of the assembly. Optical components 8, specifically a mirror and a lens, are associated with the screen 1.

The optical imager 5 is made up of a propagation prism 5a, a backing prism 5b, a quarterwave plate 5c, and a spherical Mangin mirror 5d. The spherical Mangin mirror is a piano-spherical lens in which the spherical face has been made reflective by treating it with aluminum or equivalent.

The imager 5 also includes a polarization-separator treatment 6 that can be provided in the form of a deposit of thin layers either on the propagation prism 5a or on the backing prism 5b, or by means of a film bonded between the two above-mentioned elements.

The imager 5 is embedded in a lens 9 and the casing is disposed facing forwards behind the lens, a reflective treatment 5e therefore being included in the lens. On the same principle, the casing could be disposed on the side of the lens 9, with the reflective element 5e then being absent.

The word “lens” relates in particular to an optionally-corrective lens for mounting in an eyeglass frame. The ophthalmic eyeglass lens presents conventional features: vision correction, anti-glare protection, dirt-proofing, scratch-proofing, for example.

It is known to fasten the light-beam generator system on the lens and also to use the following arrangement to make it possible to adjust the focus to adjust the distance at which the information image is seen, and consequently to set that distance so as to provide the wearer with clear and comfortable vision. The lens is secured to an adapter that is constituted by a plate carrying two rods on which the casing of the light-beam generator system is engaged and can slide. During such adjustment, the casing is manually engaged to a greater or lesser extent on the slideways so as to adjust the distance, and then the casing is blocked by a transverse screw.

That type of connection and focus-adjuster device poses the following technical problems.

Depending on the position, the overall bulk of the display varies. This can lead to a constraint in its production.

That type of device inevitably leads to significant play between rods and slideways, and that is prejudicial to the accuracy of the display.

In general, the casing is made of plastics material, and the plate with its rods is made of metal. This results in rapid wear of the casing, further increasing play, and consequently increasing the inaccuracy of the display.

Finally, in that prior art, adjustment is performed manually in the sense that the wearer must take hold of the casing and slide it along the rods until the correct focus is obtained. It goes without saying that such an arrangement is not very accurate, not very comfortable to use, and is poorly adapted to everyday use as opposed to experimental use.

### OBJECTS AND SUMMARY OF THE INVENTION

Consequently, it is possible to envisage providing a display that is fitted with an adjuster device for adjusting the focus by adjusting the length of the light beams between the optical elements and the imager in which said adjuster device is included in the light-beam generator system, the light-beam generator system comprising, for example, a stationary plate to which at least one of the optical elements is connected via a movable connection that is adjustable by means of an actuator device.

Consequently, the connection between the light-beam generator system and the lens no longer requires distance adjustment, but it must barely be visible on the lens for appearance purposes, while providing accurate positioning and retention and being easy to put into place.

To do this, the invention proposes an ophthalmic display comprising an optical imager both for shaping light beams emitted by a miniature screen of a light-beam generator system for generating light beams that are introduced into said imager via an inlet face, and for directing them towards the eye of the wearer so as to make it possible to view an image, an adapter being in a reference position relative to the imager, and said light-beam generator system including a connection arrangement for connection to said adapter, the connection between said system and said adapter being releasable, wherein said adapter is constituted by at least two snap-fastener hooks for housing in housings carried by said connection arrangement.

The advantage of this type of solution resides in its suitability for fastening a light-beam generator system on an information lens or eyeglass lens subject to significant constraints in mechanical, optical, bulk, weight, and appearance terms.

The number of parts used is minimized. Use takes place without actuating any external tool, quickly and easily. The absence of rubbing parts ensures that positioning accuracy is preserved. In terms of appearance, the residual parts on the information eyeglass lens, namely the two hooks, are very discrete. The general bulk of the connection system is minimal, as much in the light-beam generator system as on the lens. The contribution to the total weight is minimal given that the parts dedicated solely to fastening are the hooks.

In a preferred embodiment, said hooks are anchored in bores in said inlet face of said imager.

Preferably, said connection arrangement carried by the light-beam generator system includes two substantially parallel arms, each of which carries a respective one of said snap-fastener housings, with one of said housings being carried by a tab that is arranged in a “top” one of said arms, with said tab being elastically deformable in a direction that is substantially parallel to an axis connecting the axes of said housings, and being directed substantially perpendicularly to said axis.

Advantageously, said connection arrangement carried by the light-beam generator system also includes two bearing studs, each stud being carried by a respective arm, and one of the studs being carried by a prong that is arranged in the bottom arm, said prong being elastically deformable in a direction that is substantially perpendicular to an axis connecting the axes of said housings, and being directed substantially perpendicularly to said axis.

Advantageously, said bearing studs are disposed on either side of a longitudinal plane of the connection arrangement and containing said axis.

Preferably, said connection arrangement is machined in a plate of said light-beam generator system.

Advantageously, said imager is integrated in a lens.

In an improvement of the invention, said hooks are made of conductive material.

Preferably, said snap-fastener housings are made of conductive material and are connected to a voltage source.

The invention also provides a lens forming a display as specified above, the lens including two electrodes that are disposed facing each other over at least a portion of its surface, and between which there is disposed an electrically-stimulated variable light-transmission system.

Preferably, one of said hooks is in electrical contact with one of said electrodes, and the other of said hooks is in electrical contact with the other of said electrodes.

Advantageously, each of said hooks passes through said electrodes.

Said light transmission system may be a liquid-crystal system.

The invention provides a pair of lenses that are interconnected via a nose bridge and that includes at least one lens as mentioned above.

Finally, the invention relates to a pair of lenses including a lens as specified above, wherein the other lens also includes two electrodes that are disposed facing each other over at least a portion of its surface, and between which there is disposed an electrically-stimulated variable light-transmission system.

Preferably, conductors are disposed in said bridge and they provide the electrical connection for the electrodes of said lenses.

### BRIEF DESCRIPTION OF THE DRAWINGS

The invention is described in greater detail below with reference to the figures which merely show a preferred embodiment of the invention.

FIG. 1, is a diagrammatic plan view of a known display, and is described above.

FIG. 2 is a fragmentary perspective view of an ophthalmic display of the invention.

FIG. 3 is an exploded side view of FIG. 2.

FIGS. 4 and 5 are fragmentary perspective views of an ophthalmic display of the invention.

FIGS. 6 and 7 are perspective views of an ophthalmic display of the invention.

FIG. 8 is a section view showing an improvement to the invention.

FIG. 9 is a longitudinal section view showing a pair of eyeglasses, illustrating the improvement.

### MORE DETAILED DESCRIPTION

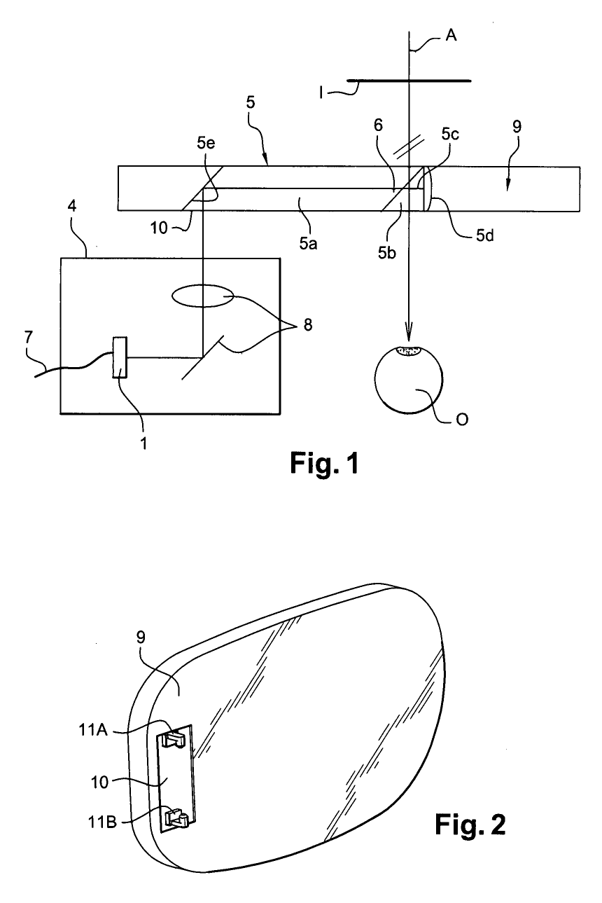

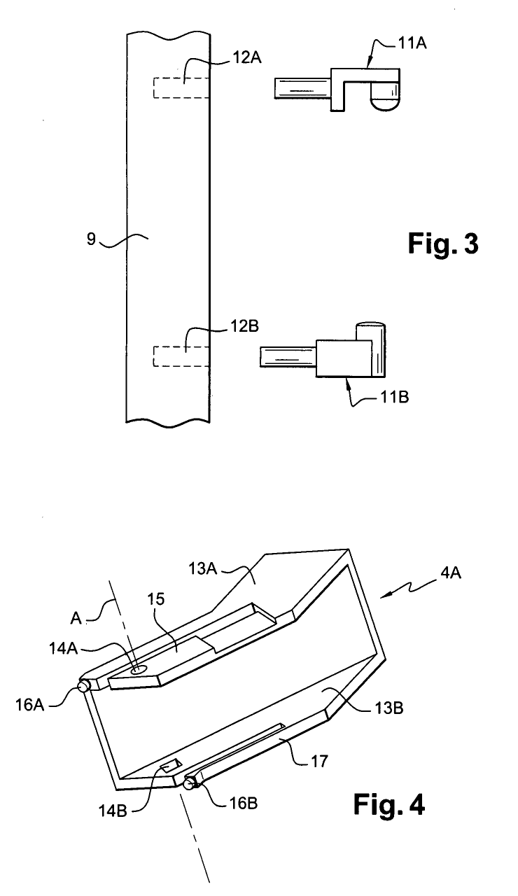

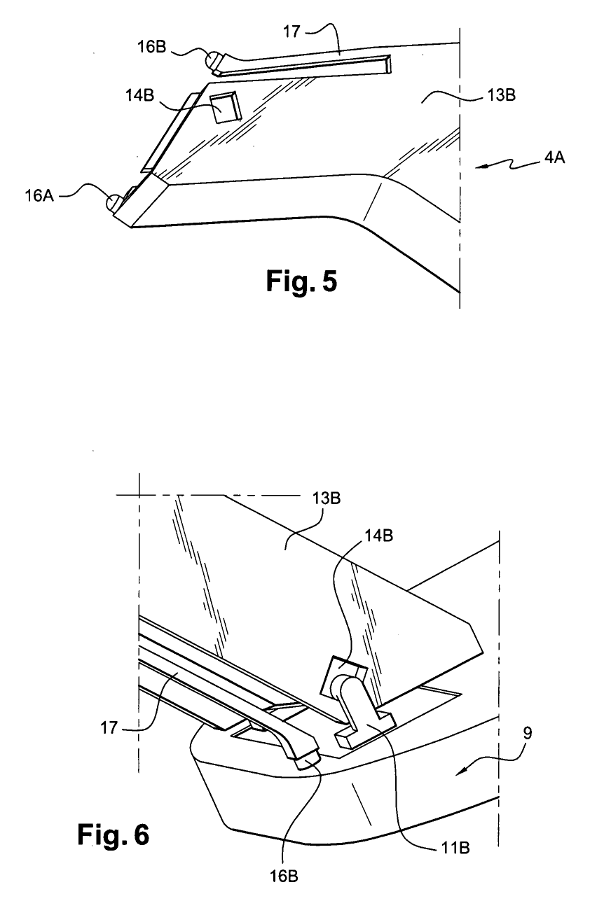

FIGS. 2 and 3 show a lens 9 that is constituted by an optionally-corrective lens for mounting in an eyeglass frame. As shown in FIG. 1, an optical imager 5 is inserted in the lens 9, with only the inlet face 10 for the light beams being visible in FIG. 2. The light beams are emitted by a miniature screen of a light-beam generator system 4 that is shown in FIGS. 4 and 5.

An adapter is in a reference position relative to the imager, i.e. is secured to the imager or to the lens, in accurate manner, in order to ensure that the light beams are transmitted in correct and optimum manner inside the imager, and in order to ensure that they are propagated towards the eye O of the wearer, so as to make it possible to view an image I. The adapter is constituted by two snap-fastener hooks 11A, 11B that are anchored in bores 12A, 12B that are arranged in the inlet face 10 of the imager that is inserted in the lens 9, e.g. by being embedded therein.

It is possible to envisage making the adapter with more than two hooks as described above, with the hooks barely being visible on the lens for appearance purposes.

The snap-fastener hooks 11A, 11B can be made of metal or of plastics material and are for housing in housings carried by a connection arrangement 4A that is secured to the light-beam generator system 4, the connection between the system and the adapter being removable.

The connection arrangement 4A shown in FIGS. 4 and 5 includes two substantially parallel arms 13A, 13B, each of which carries a respective one of the snap-fastener housing 14A, 14B. One of the housings 14A is carried by a tab 15 that is arranged in a “top” one 13A of the arms. The tab 15 is elastically deformable in a direction that is substantially parallel to an axis A connecting the axes of the housings, and is directed substantially perpendicularly to the axis A.

The connection arrangement 4A carried by the light-beam generator system 4 also includes two bearing studs 16A, 16B, each stud being carried by a respective arm. One of the studs 16B is carried by a prong 17 that is arranged in the bottom arm 13B. The prong 17 is elastically deformable in a direction that is substantially perpendicular to the axis A connecting the axes of the housings, and is directed substantially perpendicularly to said axis A. The bearing studs 16A, 16B are disposed on either side of a longitudinal plane of the connection arrangement and containing the axis A.

When the light-beam generator system includes a stationary plate, as mentioned above, the connection arrangement 4A is advantageously machined in said plate.

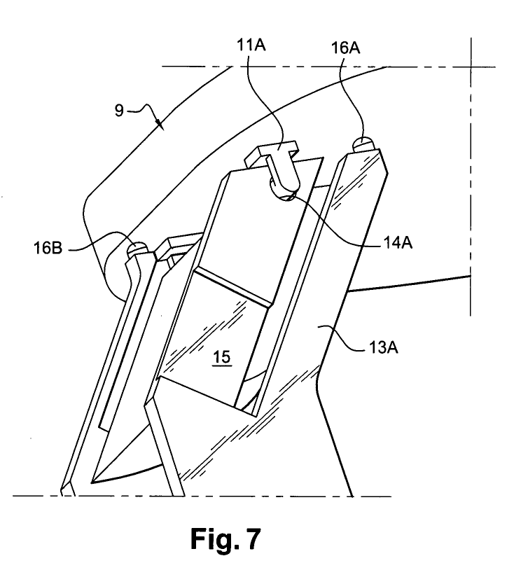

The light-beam generator system 4 can be fastened onto the lens as described below and as shown in FIGS. 6 and 7.

The bottom hook 11B is firstly inserted into the corresponding bottom housing 14B of size that is greater than the size of the corresponding hook 11B so as to enable movement during positioning. The top hook 11A is then clipped into the corresponding top housing 14A of size that is matches the size of the hook, and said clipping is done by tilting the light-beam generator system 4 upwards, and by elastically deforming the tab 15 of the top arm 13A of the connection arrangement. The tab 15 can be deformed by pressing it with a finger, or it can be deformed by means of a movable part of the casing of the light-beam generator system 4.

Conversely, in order to remove the light-beam generator system 4 from the lens 9, pressure is applied against the tab 15 and the hooks are released from their respective housings.

In a variant of the mounting, the top hook 11A can be disposed in the corresponding housing 14A and the bottom hook 11B can be put into place in the corresponding housing 14B by keeping the tab 15 deformed until both the hooks have been fully fastened.

The shape of the elastically deformable tab 15 is designed so as to provide resilience that is sufficient for a corresponding deformation and for the development of a force necessary to hold it between the two hooks, and for making it easy and effortless to manipulate for the user.

During mounting, the two abutment studs 16A, 16B come into contact with the surface of the lens 9. The top stud 16A provides rigid backing, while the other stud 16B at the bottom provides sufficient opposition to turning by the prong 17 deforming and pressing against the lens 9.

The shape of the elastically-deformable prong 17 is designed so as to provide resilience that is sufficient to obtain corresponding deformation and to develop a return force that is sufficient for blocking purposes, and for making it easy and effortless to manipulate for the user

The shape of the studs 16A, 16B is adapted so as to avoid scratches forming on the lens. Advantageously, the studs are hemi-spherical in shape. Optionally, they can also be provided with a scratch-proofing treatment or be made of a soft material, e.g. rubber.

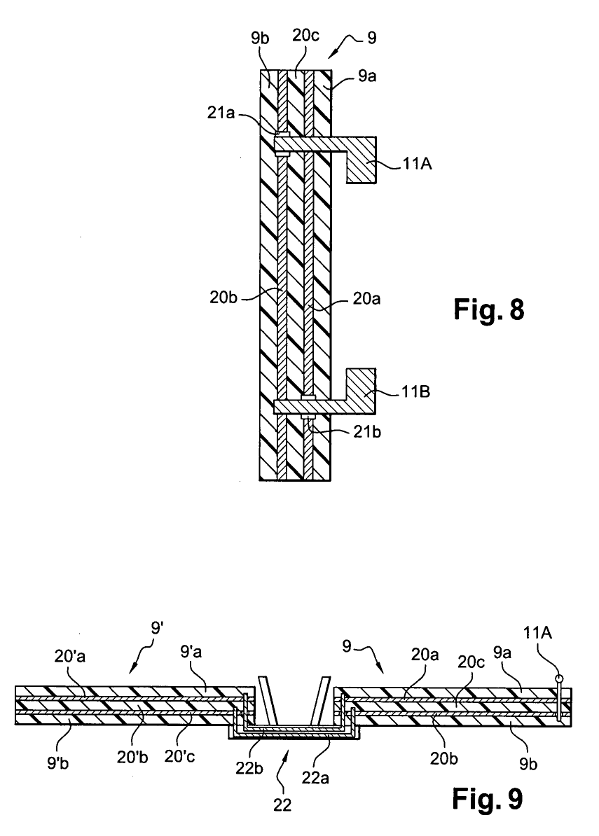

An improvement to the invention is shown in FIGS. 8 and 9.

When the imager is an insert that is integrated in a lens or in a lens of a pair of eyeglasses, it defines a volume having a surface that is equal to the front surface of the insert, and in which the view of the surroundings is interrupted. Beyond this volume, the wearer of the pair of eyeglasses can see the surroundings through the lens.

It should be observed that the information image I displayed by the system suffers from a loss of contrast due to light coming from the external surroundings being superposed thereon. This phenomenon is particularly noticeable when using the information lens outdoors.

The contrast is defined as C=(Iₒₙ−I_{off})/(Iₒₙ+I_{off}), where Iₒₙ is the intensity received by the eye when it looks at an information image placed in front of the surroundings, and I_{off} is the image received by the eye when it looks at its surrounding without an information image.

To solve this problem, the invention proposes the following improvement, judiciously adapted to the arrangement as described above.

With reference to FIGS. 8 and 9, it can be seen that two plane transparent electrodes 20a, 20b are disposed facing each other, parallel to the surface of the lens 9. The final substrate of the lens thus comprises two individual substrates 9a, 9b of transparent material constituting the ophthalmic lens proper. The electrodes 20a and 20b are disposed on the mutually-facing inner faces of the substrates 9a and 9b. At least one of the electrodes 20a or 20b can be based on indium and tin oxide or fluoride-doped tin oxide.

They are separated by a plate 20c that is constituted by a variable light-transmission system. Such a system can be of the electrochromic type, for example. In preferred manner, it is a system presenting low electricity consumption, such as a liquid-crystal based system or a system of the electrophoretic type. For such systems, the electrical stimulus that causes the variation in light transmission is an electric field that corresponds to a voltage applied between two inlet terminals of the system. The current consumed is low and is compatible with a small-sized electrical-power source.

The plate 20c is preferably a liquid-crystal system of the maintaining-voltage type or of the bistable type. A maintaining-voltage system is controlled by a voltage of about 1.5 volts (V), whereas a bistable system requires a voltage pulse of about 15 V in order to cause optical switching.

The plate 20c can be disposed on a portion of the surface of the lens, or it can be disposed on the entire surface of the lens.

Viewed from the eye to the surroundings, the lens 9 is therefore thus constituted by a superposition of layers formed by a first substrate of conventional lens material 9a, by a first electrode 20a, by a liquid-crystal plate 20c, by a second electrode 20b, and by a second substrate of conventional lens material 9b.

In this improvement, the two snap-fastener hooks 11A, 11B that are anchored in bores 12A, 12B that are arranged in the inlet face 10 of the imager that is inserted in the lens 9, e.g. being embedded therein, are of conductive material, preferably of metal.

One of the hooks 11A passes through the first electrode 20a with electrical contact, and through the second electrode 20b without electrical contact, by means of an isolating tubular element 21a. The other hook 11B passes through the first electrode 20a without electrical contact, by means of an isolating tubular element 21b, and through the second electrode 20b with electrical contact.

A conductive material can optionally be put into place where the first hook 11A is in contacting engagement with the first electrode 20a, and where the second hook 11B is in contacting engagement with the second electrode 20b, so as to provide better conduction at said locations.

The hooks 11A, 11B thus form extensions of the respective electrodes 20a and 20b, and together they constitute a switch for the plate 20C forming an electrochromic system.

The snap-fastener housings 14A, 14B of the connection arrangement 4A visible in FIGS. 5 to 7 are also made of conductive material, e.g. of metal, and they are connected to a voltage source. For example, a potential of 0 V is applied to the housing 14A for receiving the hook 11A, and a potential of 1.5 V is applied to the housing 14B for receiving the other hook 11B

When the wearer wishes to use the display, the light-beam generator system is connected to the lens by engaging the connection arrangement 4A on the hooks 11A, 11B. A voltage is thus applied between the two electrodes 20a and 20b and the liquid-crystal plate 20c darkens, acting very quickly, in a time lapse of about 10 seconds(s), to block the light emitted by the surroundings that no longer come to interfere with the view of the image I transmitted by the light-beam generator system.

For brightness lying in the range 0 candelas per square meter (cd/m²), corresponding to use in the dark, to 2000 cd/m², corresponding to use outdoors, the invention has a significant advantage. For brightness of about 1000 cd/m², a perceived contrast of about 10:1 instead of 1.49:1 as is obtained with a lens that does not have such an arrangement. This constitutes an improvement by a factor of 6.7. Contrast of 1.49:1 would not enable the image to be viewed and would not enable the ophthalmic display to be used.

Such an arrangement for improving the contrast of the image viewed by the display is arranged on the lens carrying the light-beam generator system. For a binocular display, it is arranged independently on both lenses of the pair of eyeglasses or the like.

For a monocular display in which only one lens is fitted with an imager and is intended to carry a light-beam generator system, it can be envisaged to couple the two lenses together electrically, so that they both have the same degree of lightness.

FIG. 9 shows this electrical coupling.

The lens 9 carries the hooks of which only one 11A is visible in the cross-section figure, and, as above, the lens is formed by an assembly of layers constituted by a first substrate of conventional lens material 9a, by a first electrode 20a, by a liquid-crystal plate 20c, by a second electrode 20b, and by a second substrate of conventional lens material 9b.

The second lens 9′ of the pair of eyeglasses or equivalent is identical with regard to its constitution, i.e. it is constituted by a first substrate of conventional lens material 9′a, by a first electrode 20′a, by a liquid-crystal plate 20′c, by a second electrode 20′b, and by a second substrate of conventional lens material 9′b.

The electrical connection of the first electrodes 20a and 20′a and of the second electrodes 20b and 20′b is assured via the nose bridge 22 by means of conductors 22a and 22b that can be connected to the electrodes in a manner similar to the connection of the hooks, i.e. by passing through each electrode, and providing suitable electrical contact and suitable electrical isolation.

Thus, while the light-beam generator system is fastened on the lens 9, both lenses darken in the same manner since the voltage between each pair of electrodes is identical.

1. An ophthalmic display comprising:
an optical imager both for shaping light beams emitted by a miniature screen of a light-beam generator system for generating light beams that are introduced into said imager via an inlet face, and for directing them towards the eye of the wearer so as to make it possible to view an image;
an adapter being in a reference position relative to the imager, and wherein said light-beam generator system includes a connection arrangement for connection to said adapter, the connection between said system and said adapter being releasable, wherein said adapter is at least two snap-fastener hooks for housing in housings carried by said connection arrangement.

2. A display according to claim 1, wherein said hooks are anchored in bores in said inlet face of said imager.

3. A display according to claim 1, wherein said connection arrangement carried by the light-beam generator system includes two substantially parallel arms, each of which carries a respective one of said snap-fastener housings, with one of said housings being carried by a tab that is arranged in a “top” one of said arms, with said tab being elastically deformable in a direction that is substantially parallel to an axis connecting the axes of said housings, and being directed substantially perpendicularly to said axis.

4. A display according to claim 3, wherein said connection arrangement carried by the light-beam generator system also includes two bearing studs, each stud being carried by a respective arm, and one of the studs being carried by a prong that is arranged in the bottom arm, said prong being resilient in a direction that is substantially perpendicular to an axis connecting the axes of said housings, and being directed substantially perpendicularly to said axis.

5. A display according to claim 4, wherein said bearing studs are disposed on either side of a longitudinal plane of the connection arrangement and containing said axis.

6. A display according to claim 1, wherein said connection arrangement is machined in a plate of said light-beam generator system.

7. A display according to claim 1, wherein said imager is integrated in a lens.

8. A display according to claim 7, wherein said hooks are made of conductive material.

9. A display according to claim 8, wherein said snap-fastener housings are made of conductive material and are connected to a voltage source.

10. A lens forming a display according to claim 8, the lens including two electrodes that are disposed facing each other over at least a portion of its surface, and between which there is disposed an electrically-stimulated variable light-transmission system.

11. A lens according to claim 10, wherein one of said hooks is in electrical contact with one of said electrodes, and the other of said hooks is in electrical contact with the other of said electrodes.

12. A lens according to claim 11, wherein each of said hooks passes through said electrodes.

13. A lens according to claim 10, wherein said light transmission system is a liquid-crystal system.

14. A pair of lenses that are interconnected via a nose bridge, and that includes at least one lens according to claim 10.

15. A pair of lens including a lens according to claim 10, wherein the other lens also includes two electrodes that are disposed facing each other over at least a portion of its surface, and between which there is disposed an electrically-stimulated variable light-transmission system.

16. A pair of lens according to claim 15, wherein conductors are disposed in said bridge and they provide the electrical connection for the electrodes of said lenses.
